(19) United States
(12) Patent Application Publication
(10) Pub. No.: US 2016/0334427 A1
(43) Pub. Date: Nov. 17, 2016

(54) PRIORITY INDICATOR FOR AUTOMATION SYSTEM FLUID SAMPLE

(71) Applicant: SIEMENS HEALTHCARE DIAGNOSTICS INC., Tarrytown, NY (US)

(72) Inventor: Keld Sorensen, Hackettstown, NJ (US)

(73) Assignee: Siemens Healthcare Diagnostics Inc., Tarrytown, NY (US)

(21) Appl. No.: 15/111,286

(22) PCT Filed: Jan. 23, 2015
(86) PCT No.: PCT/US15/12587

§ 371 Date: Jul. 13, 2016

Related U.S. Application Data
(60) Provisional application No. 61/931,303, filed on Jan. 24, 2014.

(51) Int. Cl. G01N 35/00; B01L 3/00

(52) U.S. Cl. CPC G01N 35/0095; B01L 3/5453; B01L 2300/021; G01N 2035/00752; G01N 2035/041

(57) ABSTRACT

An in vitro diagnostics automation system is provided that includes a track and a plurality of sample containers configured to hold a fluid sample to be processed at one or more testing stations. The system also includes one or more priority indicators each configured to be coupled to the plurality of sample containers. Each of the one or more priority indicators includes distinguishing imaging features that indicate information associated with a fluid sample in a corresponding sample container. The system also includes an imaging device configured to image the one or more priority indicators having the distinguishing imaging features imaged by the imaging device. The system further includes a processor configured to determine the information associated with the fluid sample in the corresponding sample container from the distinguishing imaging features and control processing of the sample container based on the distinguishing imaging features imaged by the imaging device.

### CROSS-REFERENCE TO RELATED APPLICATIONS

This application claims priority to U.S. provisional application Ser. No. 61/931,303 filed Jan. 24, 2014, which is incorporated herein by reference in its entirety.

### TECHNOLOGY FIELD

The embodiments disclosed herein relate in general to in vitro diagnostics automation systems and, more particularly, to priority indicators of samples for use with in vitro diagnostics automation systems.

### BACKGROUND

In vitro diagnostics (IVD) allows laboratories to assist in the diagnosis of disease based on assays performed on patient fluid samples. IVD includes various types of analytical tests and assays typically conducted with automated clinical chemistry analyzers (analyzers) onto which fluid containers, such as tubes or vials containing patient samples (e.g., blood samples), have been loaded. The analyzer extracts a fluid sample from the vial and combines the sample with various reagent fluids (reagents) in special reaction cuvettes or tubes (referred to generally as reaction vessels). Some conventional automation systems include tracks for transporting samples among the analyzer.

Samples may have different processing priority assignments. For example, some samples (e.g., short turnaround time (STAT) samples) may have priority that should take precedent over other samples destined for the analyzer. In some conventional systems, samples are assigned a variety of priority levels (e.g., High priority, Medium priority and Low priority). When used judiciously, different priority levels will allow certain samples to move through the testing process faster than other samples, allowing physicians or other practitioners to receive testing results more quickly.

### SUMMARY

Embodiments provide a priority indicator for use in an in vitro diagnostics automation system that includes an indicator body configured to be: (i) coupled to a portion of a sample container holding a fluid sample; and (ii) imaged by an imaging device. The indicator body includes distinguishing features configured to be imaged by the imaging device. The distinguishing features indicate information associated with the fluid sample in the sample container.

In one embodiment, the distinguishing features indicate a processing priority of the fluid sample held in the sample container to be processed at one or more testing stations of the in vitro diagnostics automation system.

In another embodiment, the distinguishing features indicate that the sample container be placed at a designated area after the fluid sample in the sample container has been processed.

According to an embodiment, the priority indicator is configured to be coupled to a top portion of the sample container and includes an inner wall defining a priority indicator opening configured to be disposed over a sample container opening when the priority indicator is coupled to the top portion of the sample container. The priority indicator also includes an extending portion that extends outward from the inner wall to an outer end of the extending portion.

In an aspect of an embodiment, the distinguishing features include at least one of: (i) an outer shape defined by the outer end of the extending portion; and (ii) a shape of the opening defined by the inner wall.

In another aspect of an embodiment, the distinguishing features include at least one color of the indicator.

In one embodiment, the priority indicator includes a top surface and the distinguishing features include markings on the top surface of the priority indicator. In an aspect of an embodiment, the markings on the top surface of the indicator include a bar code, a quick response (QR) code or a radio frequency identification (RFID) code.

Embodiments provide an in vitro diagnostics automation system that includes a track configured to provide one or more paths between one or more testing stations and a plurality of sample containers, each configured to hold a fluid sample to be processed at the one or more testing stations. The automation system also includes one or more priority indicators each configured to be coupled to a portion of one of the plurality of sample containers, each of the one or more priority indicators having distinguishing imaging features that indicate information associated with the fluid sample in a corresponding sample container. The automation system also includes an imaging device configured to image the one or more priority indicators having the distinguishing imaging features. The automation system further includes a processor configured to determine the information associated with the fluid sample in the corresponding sample container from the distinguishing imaging features of the one or more priority indicators imaged by the imaging device and control processing of the corresponding sample container based on the distinguishing imaging features imaged by the imaging device.

In one embodiment, the processor is further configured to: (i) determine a priority of the fluid sample in the one sample container; and (ii) cause the one sample container holding the fluid sample to be processed ahead of sample containers having a lower priority than the priority of the fluid sample in the one sample container.

In another embodiment, the automation system further includes an automated pick and place device and a rack holding the plurality of sample containers. The processor is further configured to cause the automated pick and place device to remove the one sample container from the rack and place the one sample container on the track ahead of sample containers having a lower priority than the priority of the fluid sample in the one sample container.

According to one embodiment, the rack holds: (i) one or more sample containers having a priority indicator indicating a first priority fluid sample; and (ii) one or more sample containers having a priority indicator indicating a second priority fluid sample. The processor is further configured to cause the automated pick and place device to: (i) remove, from the rack, the one or more sample containers having the priority indicator indicating the first priority fluid sample; and (ii) place, on the track, the one or more sample containers having the priority indicator indicating the first priority fluid sample ahead of one or more sample containers having the priority indicator indicating the second priority fluid sample.

According to another embodiment, the processor is further configured to cause the one sample container holding the fluid sample to cause the sample container be placed at a designated area after the fluid sample in the sample container has been processed based on the distinguishing features of the corresponding priority indicator.

Embodiments provide a computer implemented method of operating an in vitro diagnostics automation system. The method includes holding, in a storage area, one or more first priority sample containers configured to hold a first fluid sample to be processed at one or more testing stations, the one or more first priority sample containers being coupled to a first priority indicator having distinguishing features indicating a first priority of the fluid sample. The method also includes holding, in the storage area, one or more second priority sample containers configured to hold a second fluid sample to be processed at the one or more testing station, the one or more second priority sample containers being coupled to a second priority indicator having distinguishing features indicating a second priority of the fluid sample held in the one or more first priority sample containers, the second priority being a lower priority than the first priority. The method also includes imaging, via an imaging system, the first priority indicator coupled to the one or more first priority sample containers and the second priority indicator coupled to the one or more second priority sample containers and determining, via a processor, the one or more first priority sample containers as having the first priority based on the imaged first priority indicator coupled to the one or more first priority sample containers. The method further includes causing, via the processor, the one or more first priority sample containers to be processed at the one or more testing stations prior to the one or more second priority sample containers being processed at the one or more testing stations based on the determined first priority.

In one embodiment, the method further includes determining, via a processor, the one or more second priority sample containers as having the second priority based on the imaged second priority indicator coupled to the one or more second priority sample containers and causing the one or more first priority sample containers to be processed at the one or more testing stations prior to the one or more second priority sample containers being processed at the one or more testing stations is further based on the determined second priority.

In another embodiment, causing the one or more first priority sample containers to be processed prior to the one or more second priority sample containers further includes removing the one or more sample first priority sample containers from the storage area prior to removing the one or more sample second priority sample containers from the storage area and placing the one or more first priority sample containers on a track prior to placing the one or more second priority sample containers on the track.

According to an embodiment, determining the one or more first priority sample containers as having the first priority further includes determining the first priority based on at least one of: (i) an outer shape of the first priority indicator; and (ii) a shape of an opening of the first priority indicator defined by an inner wall of the first priority indicator.

According to another embodiment, determining the one or more first priority sample containers as having the first priority further includes determining the first priority based on a color of the first priority indicator.

In yet another embodiment, determining the one or more first priority sample containers as having the first priority further includes determining the first priority based on markings on a top surface of the first priority indicator.

According to an aspect of an embodiment, determining the one or more first priority sample containers as having the first priority further includes determining the first priority based on a bar code, a quick response (QR) code or a radio frequency identification (RFID) code.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following Figures:

FIG. 1A is a cross sectional side view of an exemplary sample tube that includes a priority indicator coupled to a top portion of the sample tube according to embodiments disclosed herein;

FIG. 1B shows a top view of an exemplary circular shaped priority indicator according to embodiments disclosed herein;

FIG. 1C shows a top view of an exemplary priority indicator with markings used as distinguishing imaging features according to embodiments disclosed herein;

FIG. 1D shows a cross sectional side view of an exemplary sample tube and a top view of an exemplary circular priority indicator with markings according to embodiments disclosed herein;

FIG. 1E shows a cross sectional side view of an exemplary sample tube and a top view of an exemplary hexagonal shaped priority indicator with markings according to embodiments disclosed herein;

FIG. 2A is a perspective view showing an exemplary track configuration for use by carriers according to embodiments disclosed herein;

FIG. 2B is a top view of the exemplary track configuration shown in FIG. 2A including an imaging system according to embodiments disclosed herein;

FIG. 3 is a system diagram illustrating exemplary system components to provide processing of priority samples according to embodiments disclosed herein; and

FIG. 4 shows an exemplary tray that includes a plurality of different sample tubes 100 to be processed at one or more testing stations for use with embodiments disclosed herein.

### DESCRIPTION OF EXEMPLARY EMBODIMENTS

Embodiments of the invention include systems and methods to provide efficient processing of priority samples on an analyzer. Embodiments of the invention utilize imaging devices (e.g., camera, optical reader) to identify information associated with the samples, such as the priority of a sample. Embodiments of the invention include a fluid priority indicator coupled to a container (e.g., a sample tube) holding the fluid sample (e.g., blood). Priority indicators may comprise distinguishing features configured to be imaged by the imaging device to indicate information associated with the samples, such as the priority level of a sample.

Embodiments of the invention identify, load, and process priority samples without reducing throughput and without increasing operator workload. Embodiments of the invention include identifying higher priority samples and processing the higher priority samples ahead of other samples (e.g., in the racks), thereby increasing system throughput and sample turnaround time. Embodiments include efficiently identifying information associated with the samples when a tray or rack of samples is loaded onto an analyzer, eliminating prior operator identification and thereby decreasing operator work load.

In conventional systems, maintenance of different sample priority typically includes manual intervention by an operator (e.g., laboratory technician). For example, when receiving a sample with an indication of a higher priority, the operator may manually over-ride queues so that the higher priority sample is processed ahead of lower priority samples. Operators may sometimes hand-carry high priority samples to an analyzer and move the high priority samples ahead of lower priority samples in the queue, increasing operator work load. Further, the operator is relied upon to notice that the sample has high priority and immediately take action, increasing the risk of operator error resulting in low priority processing of a high priority sample.

The priority of a sample is typically indicated on associated paperwork or in a laboratory information system (LIS). In some conventional automated track systems, bar codes are located on containers holding the samples (sample containers) to identify information associated with the samples (e.g., priority levels of samples and/or highly infectious samples). The information is not actionable, however, until the bar codes are read further along the track of the analyzer from where the samples are hand carried and loaded at the front of the analyzer or the track. Therefore, if an operator misses the high priority indication, the sample may be processed as a lower priority sample, increasing the time duration for obtaining results for the sample.

Automation systems may hold samples in temporary storage areas. Some conventional automation systems use racks (or trays), as temporary storage areas, for holding the sample containers and/or sample carriers that hold the containers and carry the samples around the track. Some racks may hold a large number of samples (e.g., 50 samples per rack, 100 samples per rack or 200 samples per rack). These conventional systems may include designated areas (a portion of the rack) for holding higher priority samples. Accordingly, samples in these designated areas may be given priority over other samples and sent to the front of the sample queue. For example, the first two rows, the first quarter of a rack or the first half of the rack may be designated for holding higher priority samples depending on the usual number of samples that need priority processing. These designated areas reduce the overall throughput of the system, however, because areas of the analyzer that could otherwise be utilized for processing lower priority samples are reserved for the higher priority samples regardless of whether there are higher priority samples present in the designated areas. For example, if 10-20% of the positions in a sample handler are designated for the high priority samples, but only 2% of the samples are actually high priority, the remaining 8-18% capacity is lost and will reduce the throughput of the system accordingly.

Because the number of high priority samples is generally unknown and will vary widely through the day, laboratories typically have dedicated high priority positions to accommodate peak expected numbers of high priority samples. Accordingly, if the laboratory determines a peak demand of 20% of high priority samples, 20% of the capacity (area) of the system may be designated for the high priority samples. These high priority samples may only be at peak volume for very short durations, however, because of fluctuations in demand for high priority testing.

Conventional methods for processing high priority samples also include processing high priority samples prior to being loaded on the track and processed separately from the other samples. Accordingly, because the higher priority samples and the other priority samples are separately identified the throughput is decreased. When high priority samples arrive, they are typically picked up by an operator/technician and walked to an analyzer and placed in a high priority area of a processing system, thereby increasing operator work load.

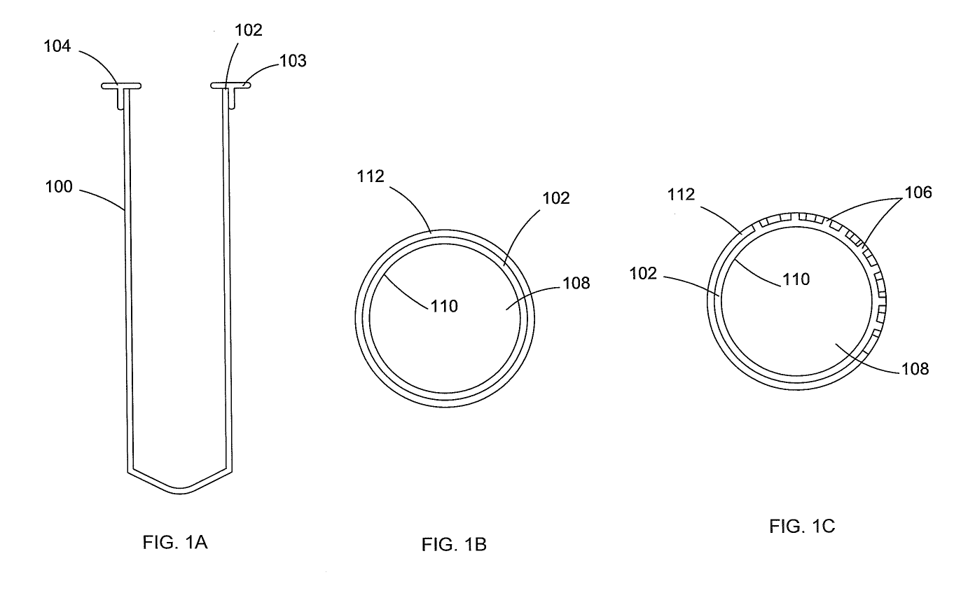

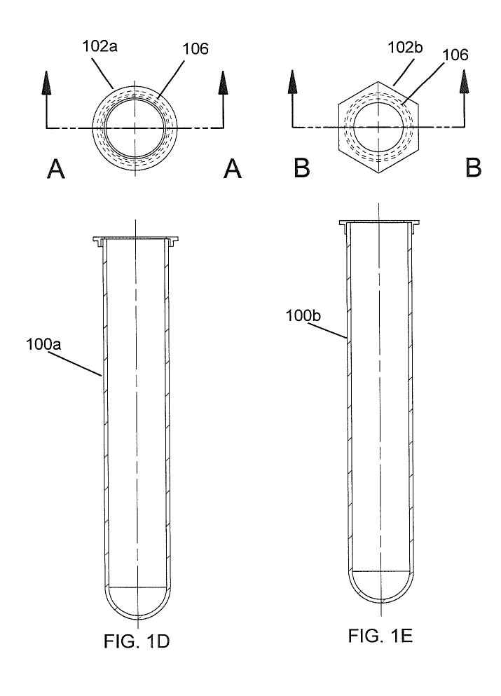

FIG. 1A through FIG. 1E show different configurations of exemplary sample tubes 100 having priority indicators 102 for use with embodiments disclosed herein. FIG. 1A is a cross sectional side view of an exemplary sample tube 100 that includes a priority indicator 102 coupled to a top portion of the sample tube 100. As shown in FIG. 1A, the priority indicator may include an indicator body 104 configured to be: (i) coupled to a portion of a sample container 100 holding a fluid sample. As shown in FIG. 1B and FIG. 1C, priority indicator 102 includes a priority indicator opening 108 configured to be disposed over a sample container 100 opening when the priority indicator 102 is coupled to the top portion of the sample container 100. The priority indicator 102 includes a collar or extending portion 103 extending outward from an inner wall 110 that defines the priority indicator opening 108 to an outer end of the extending portion 103. In one aspect, portions of the collar extend outward about 2 mm from the tube. Embodiments may, however, include portions that extend other distances from the tube.

Priority indicators may also include an opening to facilitate entry of devices into the tube. Embodiments may, however, include priority indicators having other shapes, such as triangular shapes. In some aspects, distinguishing features may include the shape of the openings. For example, priority indicators may be square with round openings.

FIG. 1B and FIG. 1C show top views of exemplary priority indicators 102 having different distinguishing imaging features. FIG. 1C and FIG. 1D also show exemplary priority indicators 102 having different distinguishing imaging features. Distinguishing imaging features may include the shape of the priority indicator 102. The distinguishing features may include at least one of: (i) an outer shape defined by the outer end 112 of the extending portion 103; and (ii) an inner shape defined by the inner wall 110. For example, the priority indicator 102 shown in FIG. 1B and FIG. 1C and the priority indicator 102a shown in FIG. 1D may be circular shaped. As shown in FIG. 1E, however, the priority indicator 102b may be hexagon shaped. The distinguishing imaging features are not, however, limited to the shapes of the priority indicators 102, 102a and 102b shown in the embodiments at FIG. 1B to FIG. 1E. Embodiments may include other priority indicators having any shape and any size.

Distinguishing imaging features may also include a color. For example, the priority indicator 102 shown in FIG. 1B and FIG. 1C may be red in color to indicate a high priority sample. The distinguishing imaging features are not, however, limited to a red color. Embodiments may include priority indicators 102 having any types of color to indicate information associated with a fluid in the sample tube 100.

Distinguishing imaging features may also include markings. For example, priority indicator 102 shown in FIG. 1C, the priority indicator 102a shown in FIG. 1D and the priority indicator 102b shown in FIG. 1E may include markings 106 to indicate information associated with a fluid in the sample tube 100. The distinguishing imaging features are not, however, limited to the markings shown in FIG. 1C to FIG. 1E. Embodiments may include other priority indicators having any types of markings to indicate information associated with a fluid in the sample tube 100. For example, the markings may include lines, shapes pictures, letters, numbers or other types of markings to indicate information associated with the sample in the tube. Embodiments may include priority indicators having markings that include bar codes, quick response (QR) codes and radio frequency identification (RFID) codes.

In the embodiments shown in FIG. 1A through FIG. 1E, priority indicators 102, 102a and 102b are coupled to sample tubes to indicate information (e.g., sample priority) associated with sample fluids in the sample tubes. Embodiments are not, however, limited to priority indicators coupled to sample tubes. Embodiments may include priority indicators coupled to other vessels, such as for example, reagent cartridges to indicate priority of reagents to be combined with sample fluids in one or more testing stations of in vitro diagnostics automation system.

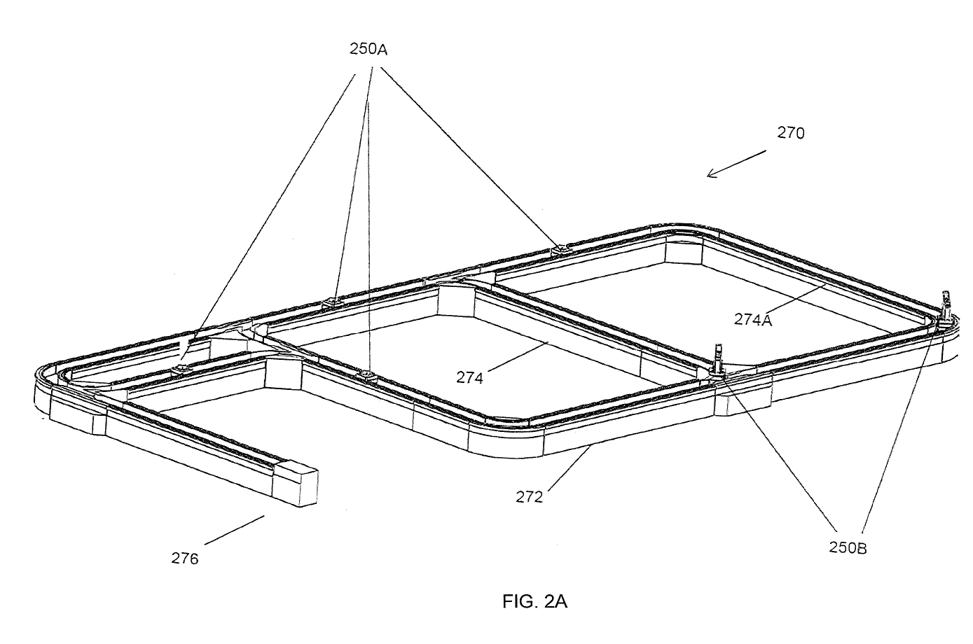

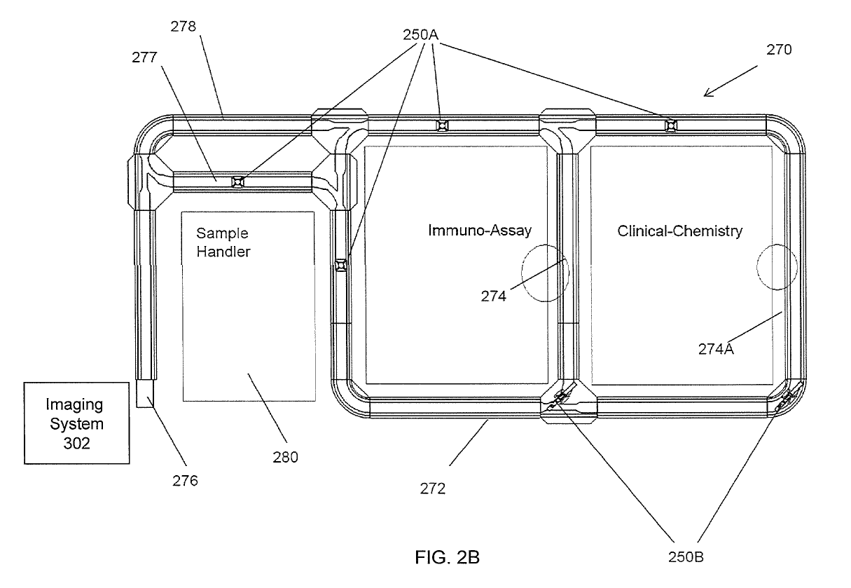

FIG. 2A shows an exemplary track configuration 270 for use by carriers 250. In this example, carriers 250A transport sample tubes, while carriers 250B transport sleeves 502 and/or racks of tubes, and/or reagent cartridges along main track 272 and/or subpaths 274 and 274A. As shown in FIG. 2B, exemplary track configuration 270 may include a tray loading/unloading area 276 by which an operator to place samples into carriers or remove samples from these carriers.

FIG. 2B shows an additional view of an exemplary track configuration 270. In this example, sub-path 274 serves an immunoassay station, while sub-path 274A serves a clinical chemistry station. Loading/unloading area 276 can be served by a sample handler station 280 that uses sub paths 277 and 278 to buffer samples for insertion or removal of the samples from the main track 272. The track configuration 270 shown in FIG. 2A and FIG. 2B is merely exemplary. Embodiments may include tracks having any type of configuration to transport vessels, such as sample tubes and reagent cartridges having priority indicators 102.

As shown in FIG. 2B, an imaging system 302 may be located adjacent to the loading/unloading area 276. Imaging system 302 may be used to image the priority indicators 102 having different distinguishing imaging features (such as those described above with reference to FIG. 1B through FIG. 1E). The location of imaging system 302 shown in the embodiment at FIG. 2B is merely exemplary. Embodiments may include an imaging system 302 at any location of an analyzer, such as above a sample loading/unloading area, proximate to a sample loading/unloading area and proximate to a reagent loading area.

In an effort to reduce the time and energy required by manual unloading and loading, some conventional systems use automated pick and place mechanisms to load and unload the individual containers to and from the carriers, resulting in large, complex and expensive systems. Even with the use of automated pick and place mechanisms and bar codes, information (e.g., priority information) associated with fluids of vessels (e.g., sample tubes) is not identified, however, until bar codes are read further along the track of the analyzer from where the samples are hand carried and loaded at the front of the analyzer.

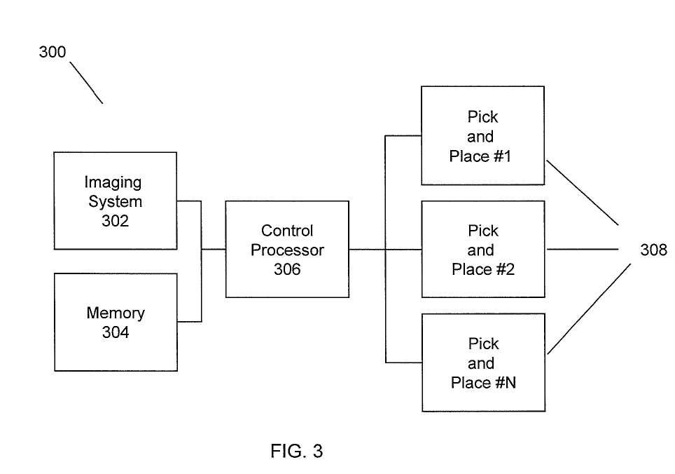

FIG. 3 is a system diagram illustrating exemplary system components to provide efficient processing of priority samples according to embodiments disclosed herein. As shown in FIG. 3, the system 300 may include imaging system 302 having one or more image devices (e.g., cameras, scanners (e.g., bar code scanners) and the like) configured to acquire images and a memory 304 which may store information, such as information associated with fluids of the sample tubes that is acquired by imaging system 302.

The system 300 may also include a control processor 306 configured to determine information associated with fluid samples in sample containers (e.g., sample tube 100 in FIG. 1A) from the distinguishing imaging features (e.g., color, shape, markings) of the priority indicators (e.g., priority indicators 102) imaged by the imaging system 302. Control processor 306 may also be configured to control processing of the corresponding sample container 100 based on the distinguishing imaging features imaged by the imaging device 302.

The system 300 may also include a plurality of automated pick and place mechanisms 308. A system may include any number of automated pick and place mechanisms. Control processor 306 may be configured to control processing of the corresponding sample container 100 by controlling the automated pick and place mechanisms 308 to pick and place vessels (e.g., sample tube 100) from and onto track 270.

An exemplary method of operating an in vitro diagnostics automation system according to an embodiment is now described with reference to FIG. 1A through FIG. 3. The method may include holding sample containers having different processing priorities in a storage area, such as storage area 276. For example, storage area 276 may include one or more first priority sample containers configured to hold a first fluid sample to be processed at one or more testing stations (e.g., Immuno-Assay testing station and Clinical-Chemistry testing station show in FIG. 2B) and one or more second priority sample containers configured to hold a second fluid sample to be processed at the one or more testing stations.

First priority sample containers may include a first priority indicator having distinguishing features indicating a first priority of the first fluid sample and second priority sample containers may include a second priority indicator having distinguishing features indicating a second priority of the second fluid sample. In this embodiment, the second priority has a lower priority than the first priority. That is, the first priority indicates that first fluid sample is to be processed at one or more testing stations prior to the second fluid sample. For example, the first priority indicator may be the priority indicator 102a shown in FIG. 1D having a circular shape as distinguishing features indicating a first priority of the fluid sample within the sample tube 100 shown in FIG. 1D. The second priority indicator may be the priority indicator 102b shown in FIG. 1E having a hexagonal shape as distinguishing features indicating a second priority of the fluid sample within the sample tube 100 shown in FIG. 1E.

In some embodiments, the first priority may indicate that fluid sample is a STAT sample. The number of priorities described herein is merely exemplary. Embodiments may include any number of priority indicators indicating any number of priorities (e.g., high priority, medium priority, low priority).

The method may also include imaging priority sample containers having sample priority indicators. In some embodiments, priority sample containers may be imaged in within a storage area, such as storage area 276. An imaging system, such as imaging system 302, may acquire images of the sample priority indicators. For example, imaging system 302 may acquire images of circular shaped priority indicator 102a coupled to sample tube 100a shown in FIG. 1D when priority sample tube 100 is in storage area 276. Imaging system 302 may also acquire images of the hexagonal shaped priority indicator 102b coupled to the second priority sample tube 100b shown in FIG. 1E.

The method may also include determining one or more sample containers as having a first priority based on the imaged priority indicator coupled to the sample container. For example, a processor, such as control processor 306 may determine the sample tube 100a shown in FIG. 1D includes a first priority based on the circular shaped priority indicator 102a coupled to the sample tube 100a shown in FIG. 1D. Processor 306 may then cause the sample tube 100a shown in FIG. 1D to be processed at the one or more testing stations prior to one or more other sample containers being processed at the one or more testing stations based on the determined first priority of the sample tube 100a shown in FIG. 1D. In this embodiment, the processor 306 may cause the sample tube 100a shown in FIG. 1D to be processed prior to sample tubes that do not include a priority indicator indicating a first priority.

In some embodiments, the processor 306 may cause the ordering of processing of different sample tubes to occur based on different priority indicators indicating different priorities. For example, processor 306 may determine: (i) sample tube 100a shown in FIG. 1D includes a first priority based on the circular shaped priority indicator 102a coupled to the sample tube 100a; and (ii) sample tube 100b shown in FIG. 1E includes a second priority based on the hexagonal shaped priority indicator 102b coupled to the sample tube 100b. Processor 306 may then cause the sample tube 100a shown in FIG. 1D to be processed at the one or more testing stations prior to sample tube 100b shown in FIG. 1E being processed at the one or more testing stations based on the determined first priority of the sample tube 100a and the determined second priority of the sample tube 100b. The different shapes of the priority indicators may be determined using imaging techniques known in the art, such as edge detection techniques.

In some embodiments, the processor 306 may cause first priority sample tubes to be processed ahead of other sample tubes by causing one or more pick and place devices, such as pick and place devices 308, to remove the first priority sample tubes from one location and place the first priority sample tubes at another location. For example, the processor 306 may cause higher priority samples to be removed from their locations in temporary storage areas (e.g., location in a tray or rack and placed by a pick and place device 308 ahead of lower priority samples at other locations (e.g., at a portion on the track or a loading area proximate to the track).

In some embodiments, the distinguishing features (e.g., shape, size, color markings) of the priority indicator may indicate that the sample container be placed at a designated area after the fluid sample in the sample container has been processed. For example, the processor 306 may cause a pick and place device 308 to place a higher priority samples (e.g., sample tube 100b shown in FIG. 1E) at designated area after the fluid sample in the sample container 100b has been processed at one or more testing stations.

The processor 306 may be a central processor or may be one of a plurality of local processors. The processor 306 may determine the priorities of samples based on the distinguishing features of corresponding priority indicators and cause higher priority samples to be removed from the temporary storage areas (e.g., trays or racks) and placed (e.g., by a pick and place device) ahead of lower priority samples (e.g., at a portion on the track or a loading area proximate to the track). In some embodiments, a single processor may be used to process an image, identify distinguishing features of priority indicators, determine the priorities of samples and cause the higher priority samples to be placed on the track ahead of the lower priority samples. In other embodiments, different processors may be used to perform the different functions.

In some embodiments, priority indicators may be used with drawer-based sample handlers to promptly identify a sample as having high priority when the tray of samples is loaded onto an analyzer. Conventional drawer-based sample handler systems include racks having a number of positions for holding the samples. Typically, in these conventional systems, the samples are loaded on the track for processing sequentially by position. For example, position 1 is loaded first, followed by position 2 and so on. If a rack contains a large number of samples (e.g., 100 samples) and a high priority sample is positioned in position 100, then it may take a long time (e.g., 700 seconds) before the system realizes that the sample in position 100 is a priority sample.

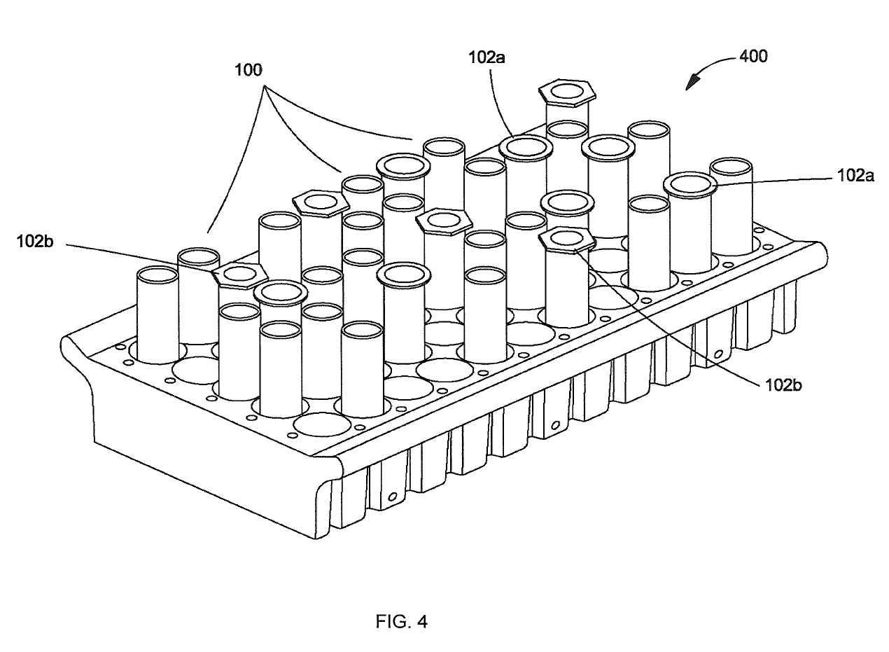

FIG. 4 shows an exemplary tray or rack 400 having a matrix of rows and columns of sample tube holding positions for use with embodiments disclosed herein. As shown in FIG. 4, a plurality of sample tubes 100 are located in different sample tube holding positions. The plurality of sample tubes 100 may include different priority indicators indicating different processing priorities. For example, as shown in FIG. 4, some sample tubes 100 may include circular shaped priority indicators 102a indicating a first priority of the fluid samples within their corresponding sample tubes 100. Other sample tubes 100 may include hexagonal shaped priority indicators 102b indicating a second priority of the fluid samples within their corresponding sample tubes 100. Further, as shown in FIG. 4, some sample tubes 100 may not include any priority indicator thereby indicating no priority of the fluid samples within their corresponding sample tubes 100.

Because the priority indicators 102a and 102b may be used to identify priority levels of samples in the tray 400, a high priority sample may be identified and placed ahead of lower priority samples, regardless of where the sample is located in the input tray 400, thereby bypassing operator identification of priority of samples and placing them in certain areas of the tray 400. For example, a processor, such as control processor 306 may determine the sample tubes 100 in various positions in tray 400 having circular shaped priority indicators 102a include a first priority and may then cause these tubes 100 to be placed (e.g., via pick and place mechanisms 308) ahead of lower priority samples (e.g., sample tubes having circular shaped priority indicators 102a and sample tubes having no priority indicators) to processed at the one or more testing stations prior to the lower priority samples containers. In some embodiments, this may include processor 306 cause the automated pick and place mechanisms to: (i) remove, from the rack 400, the one or more sample containers 100 having the priority indicator 102a indicating the first priority fluid sample; and (ii) place, on the track 270, the one or more sample containers 100 having the priority indicator 102a indicating the first priority fluid sample ahead of one or more sample containers having the priority indicator 102b indicating the second priority fluid sample.

Additionally, processor 306 may determine the sample tubes 100 having hexagonal shaped priority indicators 102a include a second priority and may then cause these tubes 100 to be placed ahead of lower priority samples (e.g., sample tubes having no priority indicators) to processed at the one or more testing stations prior to the sample tubes having no priority indicators. Accordingly, a mix of samples (e.g., samples having different priorities) may be loaded in a single tray 400 without operator identification and subsequent placement of the samples, thereby decreasing operator workflow.

Priority indicators may be used to efficiently identify information associated with the samples for systems without designated high priority sample positions or high priority sample areas. Priority indicators may allow the assembling of samples in a tray without sorting the high priority samples to particular positions. Priority indicators allow an incoming sample to be marked as a high priority sample directly on the sample in response to observing the indicator at the time of the draw of the sample, thereby preventing the operator from reviewing the priority in a LIS or paperwork system.

In some embodiments, the distinguishing features of a priority indicator may indicate that the sample be placed or sorted to a designated area after the sample has been processed. For example, distinguishing features of a priority indicator may indicate that the corresponding sample is highly infectious. Accordingly, the sample may not be processed as a priority, but may be placed at an area separate from the other samples after processing.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A priority indicator for use in an in vitro diagnostics automation system comprising:
an indicator body configured to be: (i) coupled to a portion of a sample container holding a fluid sample; and (ii) imaged by an imaging device,
wherein the indicator body comprises distinguishing features configured to be imaged by the imaging device, and
wherein the distinguishing features indicate information associated with the fluid sample in the sample container.

2. The priority indicator of claim 1, wherein the distinguishing features indicate a processing priority of the fluid sample held in the sample container to be processed at one or more testing stations of the in vitro diagnostics automation system.

3. The priority indicator of claim 1, wherein the distinguishing features indicate that the sample container be placed at a designated area after the fluid sample in the sample container has been processed.

4. The priority indicator of claim 1, wherein the priority indicator is configured to be coupled to a top portion of the sample container and comprises:
an inner wall defining a priority indicator opening configured to be disposed over a sample container opening when the priority indicator is coupled to the top portion of the sample container; and
an extending portion that extends outward from the inner wall to an outer end of the extending portion.

5. The priority indicator of claim 1, wherein the distinguishing features comprise at least one of: (i) an outer shape defined by the outer end of the extending portion; and (ii) a shape of the opening defined by the inner wall.

6. The priority indicator of claim 1, wherein the distinguishing features comprise at least one color of the indicator.

7. The priority indicator of claim 1, wherein the priority indicator comprises a top surface and the distinguishing features comprise markings on the top surface of the priority indicator.

8. The priority indicator of claim 1, wherein the markings on the top surface of the indicator comprises a bar code, a quick response (QR) code or a radio frequency identification (RFID) code.

9. An in vitro diagnostics automation system comprising:
a track configured to provide one or more paths between one or more testing stations;
a plurality of sample containers each configured to hold a fluid sample to be processed at the one or more testing stations;
one or more priority indicators each configured to be coupled to a portion of one of the plurality of sample containers, each of the one or more priority indicators having distinguishing imaging features that indicate information associated with the fluid sample in a corresponding sample container;
an imaging device configured to image the one or more priority indicators having the distinguishing imaging features; and
a processor configured to determine the information associated with the fluid sample in the corresponding sample container from the distinguishing imaging features of the one or more priority indicators imaged by the imaging device and control processing of the corresponding sample container based on the distinguishing imaging features imaged by the imaging device.

10. The automation system of claim 9, wherein the processor is further configured to: (i) determine a priority of the fluid sample in the one sample container; and (ii) cause the one sample container holding the fluid sample to be processed ahead of sample containers having a lower priority than the priority of the fluid sample in the one sample container.

11. The automation system of claim 10, further comprising:
an automated pick and place device; and
a rack holding the plurality of sample containers;
wherein the processor is further configured to cause the automated pick and place device to remove the one sample container from the rack and place the one sample container on the track ahead of sample containers having a lower priority than the priority of the fluid sample in the one sample container.

12. The automation system of claim 11, wherein the rack holds: (i) one or more sample containers having a priority indicator indicating a first priority fluid sample; and (ii) one or more sample containers having a priority indicator indicating a second priority fluid sample, and
the processor is further configured to cause the automated pick and place device to: (i) remove, from the rack, the one or more sample containers having the priority indicator indicating the first priority fluid sample; and (ii) place, on the track, the one or more sample containers having the priority indicator indicating the first priority fluid sample ahead of one or more sample containers having the priority indicator indicating the second priority fluid sample.

13. The automation system of claim 9, wherein the processor is further configured to cause the one sample container holding the fluid sample to cause the sample container be placed at a designated area after the fluid sample in the sample container has been processed based on the distinguishing features of the corresponding priority indicator.

14. A computer implemented method of operating an in vitro diagnostics automation system, the method comprising:
holding, in a storage area, one or more first priority sample containers configured to hold a first fluid sample to be processed at one or more testing stations, the one or more first priority sample containers being coupled to a first priority indicator having distinguishing features indicating a first priority of the fluid sample;
holding, in the storage area, one or more second priority sample containers configured to hold a second fluid sample to be processed at the one or more testing station, the one or more second priority sample containers being coupled to a second priority indicator having distinguishing features indicating a second priority of the fluid sample held in the one or more first priority sample containers, the second priority being a lower priority than the first priority;
imaging, via an imaging system, the first priority indicator coupled to the one or more first priority sample containers and the second priority indicator coupled to the one or more second priority sample containers;
determining, via a processor, the one or more first priority sample containers as having the first priority based on the imaged first priority indicator coupled to the one or more first priority sample containers; and
causing, via the processor, the one or more first priority sample containers to be processed at the one or more testing stations prior to the one or more second priority sample containers being processed at the one or more testing stations based on the determined first priority.

15. The method of claim 14, further comprising:
determining, via a processor, the one or more second priority sample containers as having the second priority based on the imaged second priority indicator coupled to the one or more second priority sample containers; and
wherein causing the one or more first priority sample containers to be processed at the one or more testing stations prior to the one or more second priority sample containers being processed at the one or more testing stations is further based on the determined second priority.

16. The method of claim 14, wherein causing the one or more first priority sample containers to be processed prior to the one or more second priority sample containers further comprises:
removing the one or more sample first priority sample containers from the storage area prior to removing the one or more sample second priority sample containers from the storage area; and
placing the one or more first priority sample containers on a track prior to placing the one or more second priority sample containers on the track.

17. The method of claim 14, wherein determining the one or more first priority sample containers as having the first priority further comprises determining the first priority based on at least one of: (i) an outer shape of the first priority indicator; and (ii) a shape of an opening of the first priority indicator defined by an inner wall of the first priority indicator.

18. The method of claim 14, wherein determining the one or more first priority sample containers as having the first priority further comprises determining the first priority based on a color of the first priority indicator.

19. The method of claim 14, wherein determining the one or more first priority sample containers as having the first priority further comprises determining the first priority based on markings on a top surface of the first priority indicator.

20. The priority indicator of claim 19, wherein determining the one or more first priority sample containers as having the first priority further comprises determining the first priority based on a bar code, a quick response (QR) code or a radio frequency identification (RFID) code.
